(19) United States
(12) Patent Application Publication
(10) Pub. No.: US 2020/0137950 A1
(43) Pub. Date: May 7, 2020

(54) INTERCHANGEABLE LANDSCAPING TOOL SYSTEM

(71) Applicant: Emil J. Varrichio, Hernando Beach, FL (US)

(72) Inventor: Emil J. Varrichio, Hernando Beach, FL (US)

(21) Appl. No.: 16/418,977

(22) Filed: May 21, 2019

Related U.S. Application Data
(60) Provisional application No. 62/674,579, filed on May 21, 2018.

(51) Int. Cl. A01D 7/08

(52) U.S. Cl. CPC A01D 7/08; A01D 11/06

(57) ABSTRACT

An interchangeable landscaping tool system including a landscaping tool having an elongated shaft, a rake head having a channel and a plurality of tines, and at least one interchangeable head having a base and an engaging-member. A first-end of the elongated shaft is provided as a handle of the tool and the rake head is positioned at a second-end of the elongated shaft during use. The channel extends along a top-edge of the rake head and is configured to slidably receive and removably engage one of the at least one interchangeable heads at the engaging-member for use. The engaging-member extends along a bottom-edge of the base of the at least one interchangeable head and is configured to mate with the channel extending along a top-edge of the rake head. The at least one interchangeable head includes a squeegee-head, a first-brush-head, and a second-brush-head.

### CROSS REFERENCE TO RELATED APPLICATION

The present application is related to and claims priority to U.S. Provisional Patent Application No. 62/674,579 filed May 21, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of landscaping and more specifically relates to a multi-use landscaping tool with interchangeable and removable attachments.

### 2. DESCRIPTION OF RELATED ART

Generally, landscaping refers to activities which modify the visible features of the land. Such features may include plants, hardscape, and non-solid landforms (e.g., sand, gravel, mulch, etc.). As such, many different tools may be required to adequately perform landscaping duties. One such application of landscaping includes golf courses.

A golf course is the location the game of golf is played. It includes a series of holes located on a mostly grass surfaces, which may include a teeing ground (i.e., tee-box), a fairway, the rough, greens, and/or hazards. Other surfaces may include sand, such as a bunker. Generally speaking, the teeing ground, fairway, and rough may include differing heights of grass, with the green including the shortest length of grass and requiring the most maintenance. Also, it may be desirable to remove excess water from some surfaces.

The professionals that maintain a golf course are often referred to as a ‘groundskeeper’. The groundskeeper's duties may include the trimming of grass, grooming of bunkers, and maintaining greens. With a golf course being an outside venue, outside elements may affect the groundskeeper's duties. As such, a groundskeeper may be required to use many tools to maintain a golf course in a desired condition. It is desired to provide a tool that allows a groundskeeper to maintain a golf course (or other landscape) without the need for a plurality of tools. A suitable solution is desired.

U.S. Pub. No. 2013/0247533 to Andy T. Zupan relates to a landscape and construction tool with multiple heads. The described landscape and construction tool with multiple heads includes a landscaping tool comprising a rigid shaft having a proximal and distal end and presenting a central axis, a rake head having a rake base, and a plurality of tines extending outwardly from the rake base. The rake head is oriented from about 90° to 120° relative to said central axis. A brace comprises two arms, each of the arms joined to the head at opposing sides and extending from the head and converging at the shaft. The device optionally further comprises additional heads.

### BRIEF SUMMARY OF THE INVENTION

In view of the foregoing disadvantages inherent in the known landscaping art, the present disclosure provides a novel interchangeable landscaping tool system. The general purpose of the present disclosure, which will be described subsequently in greater detail, is to provide a tool useful for landscaping which includes a wide variety of interchangeable components such that the device may be used for many different landscaping tasks in a single device.

An interchangeable landscaping tool system is disclosed herein. The interchangeable landscaping tool system provides a multi-purpose rake that can be used to rake sand, leaves and large debris or to smooth small amounts of sand in sand traps on golf courses or other landscapes.

The landscaping tool has an elongated shaft having a first-end and a second-end, a rake head having a channel and a plurality of tines, and at least one interchangeable head having a base and an engaging-member. The first-end of the elongated shaft is provided as a handle of the tool and the rake head is positioned at the second-end of the elongated shaft. The channel extends along a top-edge of the rake head and is configured to slidably receive and removably engage one of the at least one interchangeable heads at the engaging-member for use. The at least one interchangeable head is friction fit within the channel and the slot of the channel. The engaging-member extends along a bottom-edge of the base of the at least one interchangeable head and is configured to mate with the channel extending along a top-edge of the rake head. The plurality of tines extend from a bottom-edge of the rake head opposing the channel. The at least one interchangeable head includes a squeegee-head, a first-brush-head, and a second-brush-head.

The tool provides a user with a single landscaping tool with multiple uses.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an interchangeable landscaping tool system, constructed and operative according to the teachings of the present disclosure.

FIG. 1 is a perspective view of the interchangeable landscaping tool system, according to an embodiment of the disclosure.

FIG. 2 is a perspective view of the interchangeable landscaping tool system of FIG. 1 including an engaged squeegee-head, according to an embodiment of the present disclosure.

FIG. 3A is a perspective view of the interchangeable landscaping tool system of FIG. 1 comprising a second-brush-head, according to an embodiment of the present disclosure.

FIG. 3B is a perspective view of the interchangeable landscaping tool system comprising a first-brush-head, according to an embodiment of the present disclosure.

FIG. 4 is a perspective view of the interchangeable landscaping tool system of FIG. 1, according to an embodiment of the present disclosure.

FIG. 5 is a side view of the interchangeable landscaping tool system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to landscaping and more particularly to an interchangeable landscaping tool system as used to provide an effective and efficient multi-use landscaping tool with interchangeable and removable attachments.

The present disclosure includes a rake that can be used to rake sand, leaves and large debris or to smooth small amounts of sand in sand traps on golf courses or other landscapes. Several additional heads for performing tasks necessary on golf courses (and/or other landscapes) may be attached to the same handle.

The device provides a single, multi-use tool needed for keeping golf courses and/or yards well-maintained. The rake head, attached at the end of the handle, has a slot for attaching one of several heads to the opposite side. These other heads include a squeegee for removing water from different surfaces, like greens on a golf course or a driveway, and two different brushes. The brush head with short bristles is ideal for removing debris from putting surfaces (e.g., greens) while the brush head with longer bristles can be used like a broom as desired. The bottom edges of these attachments are shaped to fit into the slot on the top edge of the rake and to lock securely into place.

The tool can be simply rotated when the user desires to use the head attached to the opposite side of the apparatus. The tool will be constructed from high-density recycled plastic, such that the device will maintain its integrity and durability during multiple uses and outside elements. The interchangeable landscaping tool may be available in different colors, dependent upon user preferences and specific uses.

The unique features of this product provide the following benefits for consumers everywhere: a single tool that can be used for doing a variety of tasks necessary for maintaining golf courses and yards, the rake head is one unit and is as wide as an average push broom, the design of the lock between the rake head and other attachments will be made with a tight tolerance, so the other heads can be attached without needing additional hardware, the tool will be available with different colored handles, including black and green, and will be handy to use when cleaning around a golf course or a homeowner's back yard, as this single tool can be used instead of having to use several other tools.

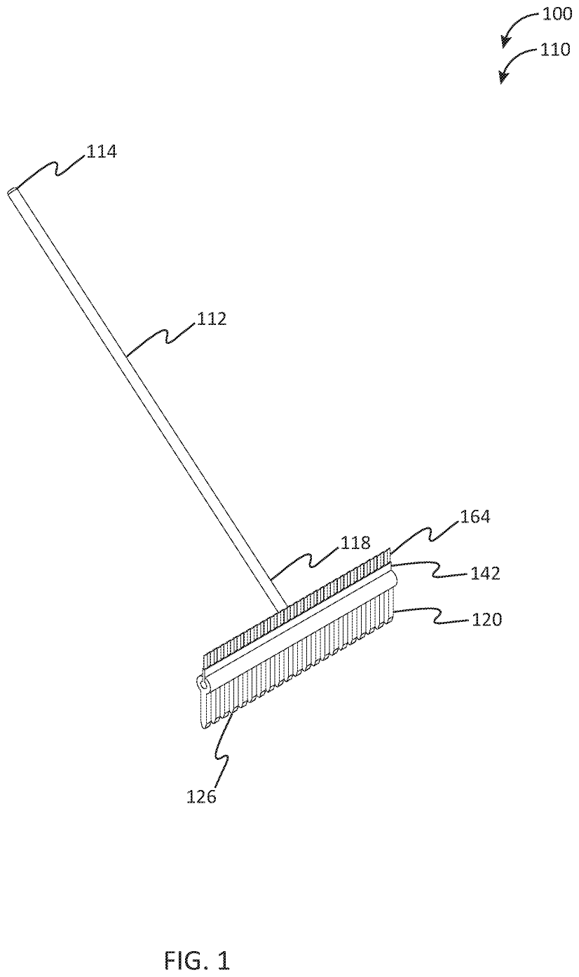

Referring now more specifically to the drawings by numerals of reference, there is shown in FIGS. 1-5, various views of an interchangeable landscaping tool system 100. FIG. 1 shows an interchangeable landscaping tool system 100 during an ‘in-use’ condition 150, according to an embodiment of the present disclosure. As illustrated, the interchangeable landscaping tool system 100 may include a landscaping tool 110 having an elongated shaft 112 having a first-end 114 and a second-end 118, a rake head 120 having a channel 122 and a plurality of tines 126, and at least one interchangeable head 140 having a base 142 and an engaging-member 144. The first-end 114 of the elongated shaft 112 is provided as a handle of the landscaping tool 110 and the rake head 120 is positioned at the second-end 118 of the elongated shaft 112. The channel 122 extends along a top-edge 124 of the rake head 120 and is configured to slidably receive and removably engage one of the at least one interchangeable heads 140 at the engaging-member 144 for use. The engaging-member 144 extends along a bottom-edge 141 of the base 142 of the at least one interchangeable head 140 and is configured to mate with the channel 122 extending along the top-edge 124 of the rake head 120. The plurality of tines 126 extend from a bottom-edge 125 of the rake head 120 opposing the channel 122.

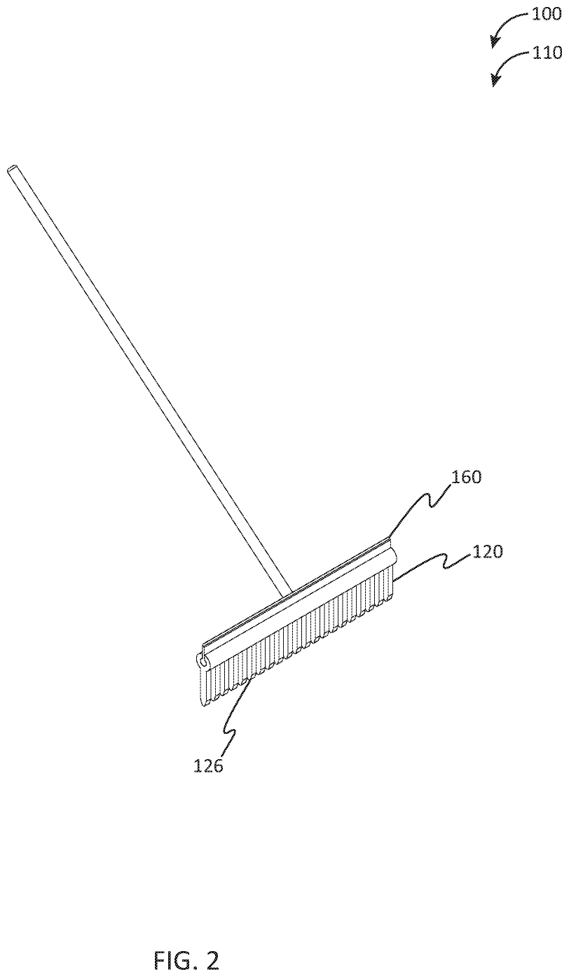

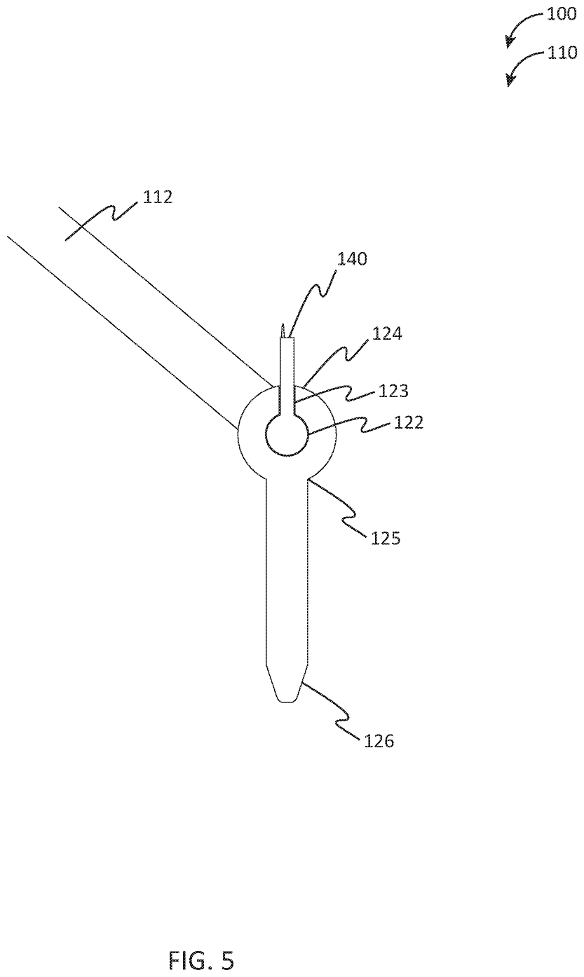

FIG. 2 shows a perspective view of the interchangeable landscaping tool system 100 of FIG. 1, according to an embodiment of the present disclosure. As above, the interchangeable landscaping tool system 100 may include the landscaping tool 110 having the elongated shaft 112, the rake head 120 having a channel 122 and the plurality of tines 126, and at least one interchangeable head 140 having the base 142 and the engaging-member 144. The at least one interchangeable head 140 includes a squeegee-head 160, a first-brush-head 162, and a second-brush-head 164. As further shown in FIG. 5, the channel 122 comprises a circular profile. The channel 122 further comprises a slot 123 extending an entire length of the channel 122. The slot 123 receives the base 142 of the interchangeable head 140. The engaging-member 144 of the at least one interchangeable head 140 comprises a circular profile configured to slide within the channel 122 and the slot 123.

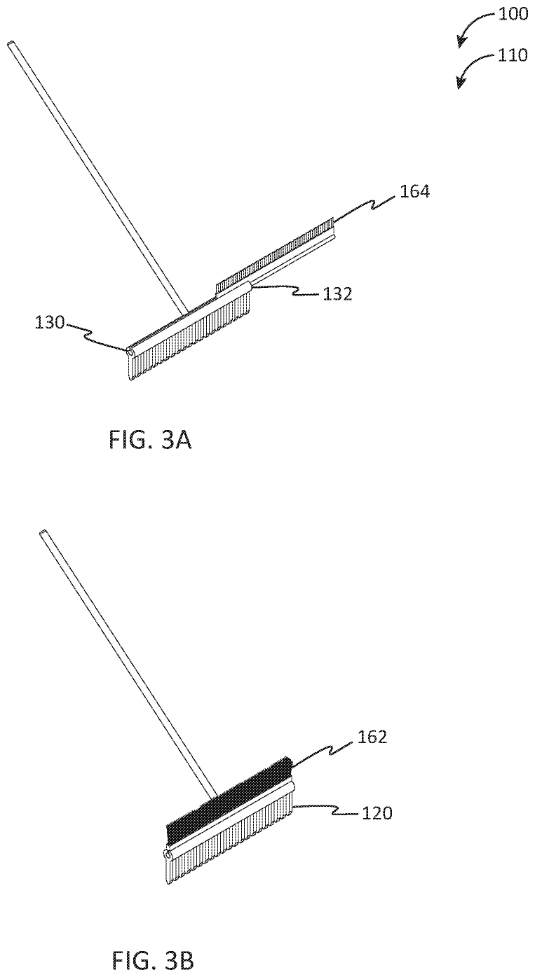

As shown in FIG. 3B, the first-brush-head 162 comprises long bristles extending from the base 142 and may be used for sweeping surfaces similar to a broom. The second-brush-head 164, shown in FIG. 3A, comprises short rigid bristles extending from the base 142. In a preferred embodiment, the second-brush-head 164 comprises a double row of the short rigid bristles. The second-brush-head 164 may be used for sweeping or removing debris such as sand or other similar fine materials from a smooth or semi-smooth surface, putting surfaces (e.g., greens), or other surface. As shown in FIG. 2, the squeegee-head 160 comprises a squeegee extending from the base 142 of the at least one interchangeable head 140.

As above, the interchangeable landscaping tool system 100 may include the at least one interchangeable head 140 is friction fit within the channel 122 and the slot 123 of the channel 122. The landscaping tool 110 is rotatable 180 degrees to use the at least one interchangeable head 140 and the rake head 120 alternatively depending on task requirements. The elongated shaft 112 may be constructed from a wide variety of materials. As such, the materials may include high-density recycled plastic materials. Alternate materials may include other plastics, plastic-like materials, metallic materials, fiberglass, carbon-fiber, or a combination thereof. Similarly, the rake head may be constructed from any suitable material.

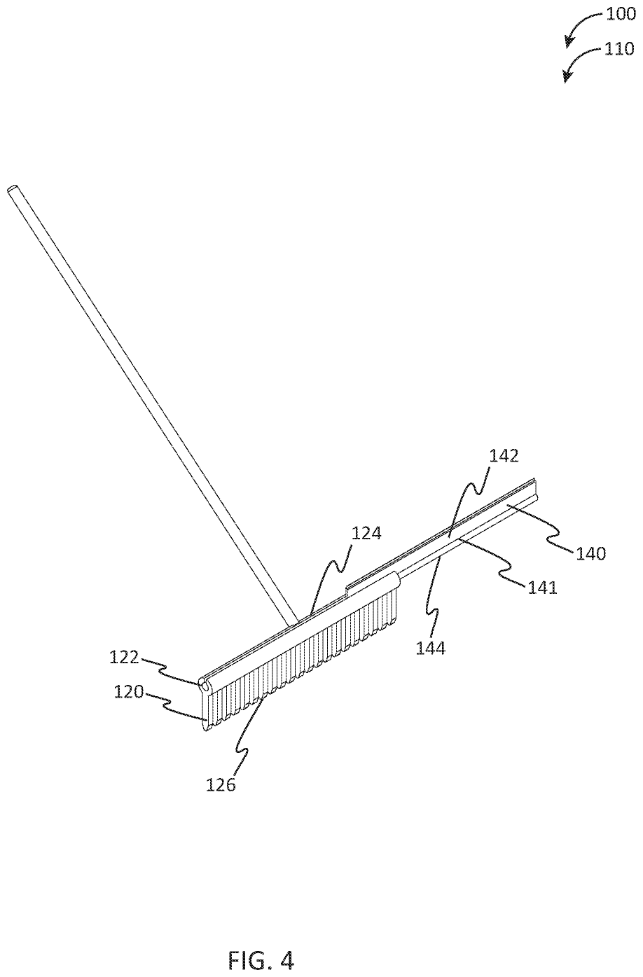

FIG. 4 shows a perspective view of the interchangeable landscaping tool system 100 of FIG. 1, according to an embodiment of the present disclosure. As above, the interchangeable landscaping tool system 100 may include the landscaping tool 110 having the elongated shaft 112, the rake head 120, and at least one interchangeable head 140. The channel 122 is open-ended at a first-end 130 and a second-end 132. The first-end 130 and the second-end 132 each being able to receive the engaging-member 144 and the base 142 of the at least one interchangeable head 140 interchangeably. The rake head 120 is affixed to the second-end 118 of the elongated shaft 112 at a favorable angle such that the present invention can be used with relative ease and efficiency for extended durations. The plurality of tines 126 are separated by equidistant gaps. The plurality of tines 126 of the rake head 120 may be straight or curved.

FIG. 5 shows a side view of the interchangeable landscaping tool system 100 of FIG. 1, according to an embodiment of the present disclosure. As above, the interchangeable landscaping tool system 100 may include the landscaping tool 110 having the elongated shaft 112, the rake head 120 having the channel 122, and the plurality of tines 126, and at least one interchangeable head 140 having the base 142 and the engaging-member 144. The rack head 120 and the at least one interchangeable head 140 being at 180 degrees to each other on a common plane during an engaged condition.

According to one embodiment, the interchangeable landscaping tool system 100 may be arranged as a kit 105. In particular, the interchangeable landscaping tool system 100 may further include a set of instructions. The instructions may detail functional relationships in relation to the structure of the interchangeable landscaping tool system 100 such that the interchangeable landscaping tool system 100 can be used, maintained, or the like, in a preferred manner.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An interchangeable landscaping tool system comprising:
a landscaping tool having;
an elongated shaft having;
a first-end; and
a second-end;
a rake head having;
a channel; and
a plurality of tines;
at least one interchangeable head having;
a base; and
an engaging-member;
wherein said first-end of said elongated shaft is provided as a handle of said tool and said rake head is positioned at said second-end of said elongated shaft;
wherein said channel extends along a top-edge of said rake head and is configured to slidably receive and removably engage one of said at least one interchangeable heads at said engaging-member for use;
wherein said engaging-member extends along a bottom-edge of said base of said at least one interchangeable head and is configured to mate with said channel extending along said top-edge of said rake head; and
wherein said plurality of tines extend from a bottom-edge of said rake head opposing said channel.

2. The interchangeable landscaping tool system of claim 1, wherein said channel comprises a circular profile.

3. The interchangeable landscaping tool system of claim 2, wherein said channel further comprises a slot extending an entire length of said channel, said slot receives said base of said interchangeable head.

4. The interchangeable landscaping tool system of claim 3, wherein said engaging-member of said at least one interchangeable head comprises a circular profile configured to slide within said channel and said slot.

5. The interchangeable landscaping tool system of claim 4, wherein said at least one interchangeable head includes a squeegee-head, a first-brush-head, and a second-brush-head.

6. The interchangeable landscaping tool system of claim 5, wherein said first-brush-head comprises long bristles extending from said base.

7. The interchangeable landscaping tool system of claim 5, wherein said second-brush-head comprises short rigid bristles extending from said base.

8. The interchangeable landscaping tool system of claim 3, wherein said channel is open-ended at a first-end and a second-end, said first-end and said second-end each being able to receive said engaging-member and said base of said at least one interchangeable head interchangeably.

9. The interchangeable landscaping tool system of claim 8, wherein said at least one interchangeable head is friction fit within said channel and said slot of said channel.

10. The interchangeable landscaping tool system of claim 1, wherein said squeegee-head comprises a squeegee extending from said base of said at least one interchangeable head.

11. The interchangeable landscaping tool system of claim 1, wherein said landscaping tool is rotatable 180 degrees to use said at least one interchangeable head and said rake head alternatively depending on task requirements.

12. The interchangeable landscaping tool system of claim 7, wherein said second-brush-head comprises a double row of said short rigid bristles.

13. The interchangeable landscaping tool system of claim 1, wherein said rack head and said at least one interchangeable head being at 180 degrees to each other on a common plane during an engaged condition.

14. The interchangeable landscaping tool system of claim 1, wherein said handle comprise a high density plastic material.

15. The interchangeable landscaping tool system of claim 1, wherein said rake head is affixed to said second-end of said elongated shaft at an angle.

16. The interchangeable landscaping tool system of claim 15, wherein said plurality of tines are separated by equidistant gaps.

17. The interchangeable landscaping tool system of claim 16, wherein said plurality of tines of said rake head are straight.

18. The interchangeable landscaping tool system of claim 16, wherein said plurality of tines of said rake head are curved.

19. An interchangeable landscaping tool system, the interchangeable landscaping tool system comprising:
a landscaping tool having;
an elongated shaft having;
a first-end; and
a second-end;
a rake head having;
a channel; and
a plurality of tines;
at least one interchangeable head having;
a base; and
an engaging-member;
wherein said first-end of said elongated shaft is provided as a handle of said tool and said rake head is positioned at said second-end of said elongated shaft;
wherein said channel extends along a top-edge of said rake head and is configured to slidably receive and removably engage one of said at least one interchangeable heads at said engaging-member for use;
wherein said engaging-member extends along a bottom-edge of said base of said at least one interchangeable head and is configured to mate with said channel extending along said top-edge of said rake head;
wherein said plurality of tines extend from a bottom-edge of said rake head opposing said channel;
wherein said channel comprises a circular profile;
wherein said channel further comprises a slot extending an entire length of said channel, said slot receives said base of said interchangeable head;
wherein said channel is open-ended at a first-end and a second-end, said first-end and said second-end each being able to receive said engaging-member and said base of said at least one interchangeable head interchangeably;
wherein said engaging-member of said at least one interchangeable head comprises a circular profile configured to slide within said channel and said slot;
wherein said at least one interchangeable head includes a squeegee-head, a first-brush-head, and a second-brush-head;
wherein said first-brush-head comprises long bristles extending from said base;
wherein said second-brush-head comprises short rigid bristles extending from said base;
wherein said squeegee-head comprises a squeegee extending from said base of said at least one interchangeable head;
wherein said at least one interchangeable head is friction fit within said channel and said slot of said channel;
wherein said landscaping tool is rotatable 180 degrees to use said at least one interchangeable head and said rake head alternatively depending on task requirements;
wherein said rack head and said at least one interchangeable head being at 180 degrees to each other on a common plane during an engaged condition;
wherein said handle comprise a high density plastic material;
wherein said rake head is affixed to said second-end of said elongated shaft at an angle;
wherein said plurality of tines are separated by equidistant gaps; and
wherein said plurality of tines of said rake head are straight.

20. The interchangeable landscaping tool system of claim 19, further comprising;
a set of instructions;
said landscaping tool;
a squeegee-head;
a first-brush-head; and
a second-brush-head;
wherein the interchangeable landscaping tool system is arranged as a kit.
